(19) United States
(12) Patent Application Publication
(10) Pub. No.: US 2007/0015532 A1
(43) Pub. Date: Jan. 18, 2007

(54) Multi-function key for electronic devices

(76) Inventor: Tom Deelman, Delta (CA)

Correspondence Address: PERMAN & GREEN, 425 POST ROAD, FAIRFIELD, CT, 06824, US

(21) Appl. No.: 11/182,505

(22) Filed: Jul. 15, 2005

(51) Int. Cl. H04M 1/00

(52) U.S. Cl. 455/550.1

(57) ABSTRACT

A secondary function, such as a push-over-cellular function, is mapped to the send key of a mobile communication device or other electronic device and is activated by the down stroke of the send key. The secondary function remains activated, providing the send key is held depressed for a set period of time. If the send key is released, before the expiration of the set period of time, the secondary function is terminated and the primary function, such as call log/history is activated.

### BACKGROUND OF THE INVENTION

1. Field of the Invention

This invention relates to electronic devices having actuation keys for activating more than one function. More particularly, this invention relates to communication devices having push to talk capability. In particular a cellular telephone having multi-function keys is adapted to activate the push-to-talk function.

2. Brief Description of Related Developments

The push-to-talk(PTT) or push-over-cellular(PoC) function is a feature of many prior art communication devices and is becoming a popular feature of cellular telephones. As a result this feature is being sought by operators and carriers to enhance cellular phone operation. The basic function originated with so called walkie-talkie devices which require the push of a PTT button in order to transmit voice and a release of the PTT button in order to receive. This function has been introduced in cellular networks, such as the Nextel Cellular Network. Cellular telephones, operating in such systems, typically have a dedicated hard key which is used to activate the PoC function. This provides a convenient mode of operation. However, as PoC becomes more prolific in the marketplace, it will need to be supported by devices that do not have dedicated PoC hardkeys.

Devices without a dedicated PoC key would typically need to allocate the PoC key to an existing key, and implement the feature as a secondary function of the key, since the existing key will already have a primary function. For example, PoC can be mapped as a long keypress to the send key of a mobile communication device, which is a reasonable key to use for the PoC function.

A problem arises from the fact that PoC requires the user to press and hold the key while the user talks. In typical key operation, a long keypress event is not detected by the system software until a certain amount of time has transpired (e.g., 1.5 seconds). Unfortunately, the user is not generally aware of this delay, and begins speaking immediately upon depressing the send button, but before the PoC function is actually invoked, so the listener will not hear the beginning of the speaker's speech. This can be a troublesome defect in utility, as the first portion of every speech message is essentially “cut-off”. Even if an auditory tone is rendered to signal when the PoC is active, this delay will result in a cumbersome user experience.

It is a purpose of this invention to provide a key operation for a communication device, which activates the PoC function immediately upon depressing the key. It is another purpose of this invention to provide a key for actuating multiple function of an electronic device, that activates a secondary function upon the downstroke of the key and defaults to the primary function when the key is released within a predetermined period of time.

### SUMMARY OF THE INVENTION

In accordance with one aspect of the invention, a key is adapted to activate primary and secondary functions depending on the length of time the key is held in the depressed or down condition. The key is designed to activate the secondary function immediately on the down stroke and to default to the primary function, when an up stroke of the key occurs within a predetermined time.

In accordance with another aspect of the invention, a mobile communication device is constructed having a send key, programmable to activate multiple functions depending on the length of time the key is depressed. In the communication device of this invention, the send key is assigned the function, wherein a push-over-cellular (PoC) function is activated immediately upon depressing the send key and a call log/history function is activated, if the key is released within a predetermined period of time.

In accordance with another aspect of the invention a method of activating a PoC function is activated by depressing a multi-function key, the PoC function continues in the on state, by maintaining the key in the depressed condition for at least a predetermined period of time. The PoC function is terminated and a secondary function is activated by releasing the key within the predetermined time period.

In accordance with another aspect of the invention a computer program product is constructed in which computer readable code causes a processor to: activate a secondary function when a key is depressed; maintain the activation of the secondary function, if the key is held in the depressed condition for at least a predetermined period of time; and to activate a primary function upon the release of the key within the predetermined period of time.

### BRIEF DESCRIPTION OF THE DRAWINGS

The device and method of this invention is explained in more detail below with reference to the accompanying drawing, in which:

FIG. 1 is a block diagram of a mobile communication device in which the invention is used;

FIG. 2 is a block diagram of the key system of this invention; and

FIG. 3 is a flow chart of the method of this invention.

### DESCRIPTION OF THE PREFERRED EMBODIMENT

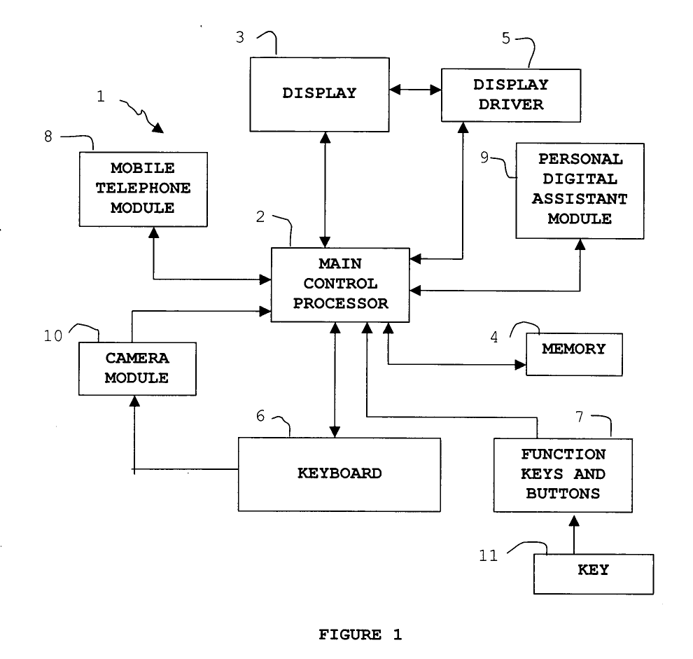

A multifunctional communication device 1, for example a combination PDA cellular telephone, incorporating features of the present invention is illustrated in the FIG. 1. Although the present invention will be described with reference to the embodiments shown in the drawings, it should be understood that the present invention may have many alternate forms. In addition, any suitable size, shape or type of elements or materials could be used.

For illustration, the invention is described with reference to a multi-function, mobile communication device 1, as shown if FIG. 1, but it should be noted that the invention may be adapted for use in any device that uses a single key to actuate multiple functions. Device 1 is a system of computer components, software components, and hardware components operatively interconnected to provide multiple functions as provided in current devices of this type. Mobile communication device 1 is constructed having a control processor 2 for providing computer functions for the various modules in conjunction with memory 4. Memory 4 is used to store software, settings, and other data for operation of the various functions. The user interface of the device 1 includes a display 3 with a display driver 5 and a keyboard 6. Miscellaneous functions, such as power on, scrolling, volume, etc. are accessible through function buttons and keys 7. In an alternative embodiment, Keyboard 6 and buttons and keys 7 may be implemented as part of a touch screen display. A series of function modules, such as mobile telephone module 8, PDA module 9, and camera module 10 may be constructed with the necessary components interconnected with control processor 2 to provide the indicated feature.

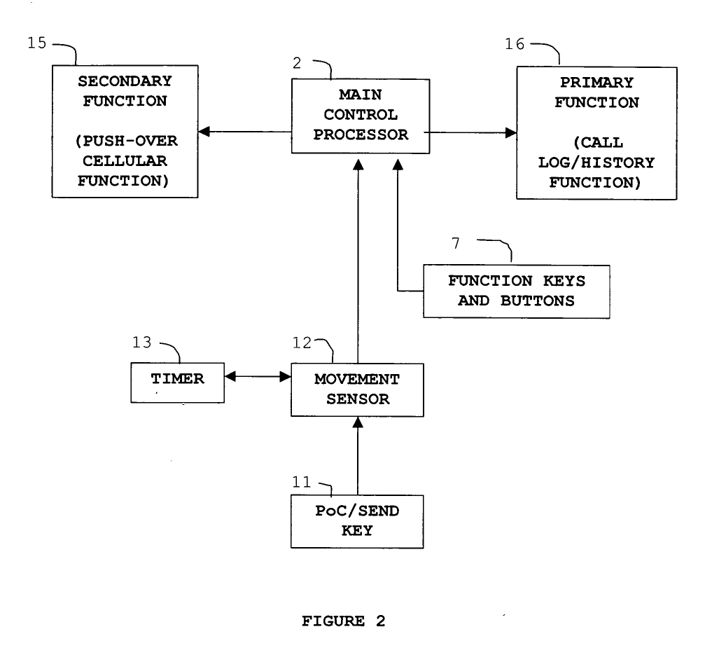

As part of the array of function keys 7, or separately, there is provided at least one key 11. According to this invention, key 11 is adapted to activate functions that vary with the application selected and with the specific operation of the key. For the purpose of illustration, activation of key 11 triggers processor 2 to activate a primary and secondary function. The function activated is dependent on the length of time the key 11 is depressed. As an example, this function may be provided by an arrangement of components, such as shown in FIG. 2, and can be a combination of processor components and software within processor 2, a dedicated component, such as an application specific integrated circuit, or any other combination of such components.

As shown in FIG. 2, the components include key 11, sensor 12, and a timer 13. The key 11 may be any type of key commonly employed in keypads of mobile telephones and the like. The key 11 is pressed to actuate sensor 12. Sensor 12 may be a microswitch or some other means of generating a signal in response to movement of the key 11. Timer 12 is activated by sensor 12. In this manner operation of key 11 may detected.

In prior art systems, the primary function is activated on the down stroke of key movement and the function is switched to the secondary function unless the upstroke of such movement, occurs before the expiration of a predetermined period of time, for example 1 to 1.5 seconds. This generates a delay when the user is selecting the secondary function, which may prove bothersome depending on the secondary function.

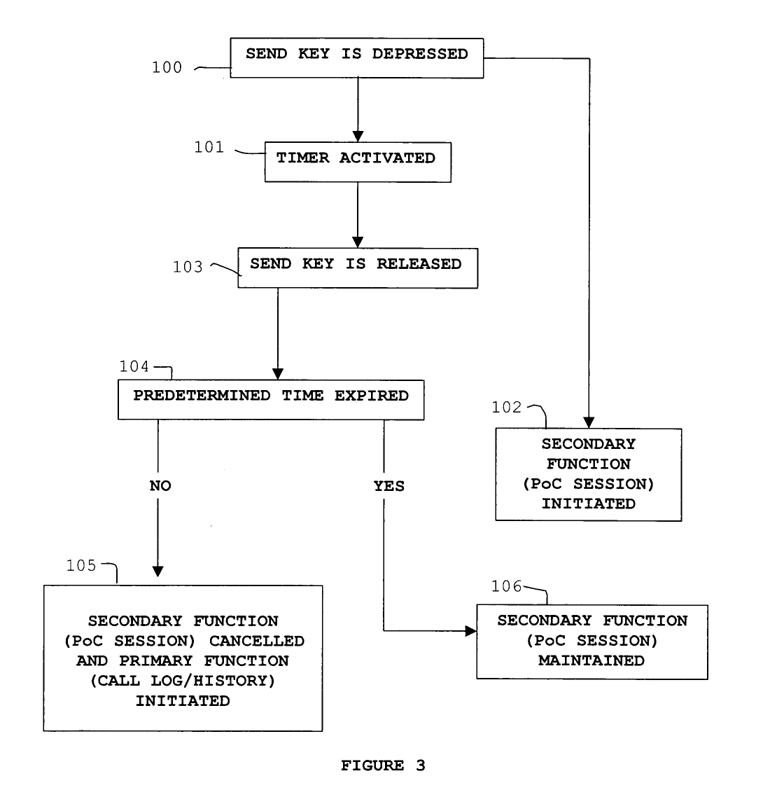

According to the system of this invention, the secondary function is activated on the down stroke of step 100, as shown in FIG. 3. Depression of key 11, causes sensor 12 to activate timer 13 (step 101 of FIG. 3). The depression of the key 11 also activates the secondary function, according to step 102 of FIG. 3. In step 103 of FIG. 3, key 11 is released and in step 104, the time expired is compared to a predetermined time that is set to distinguish between the selection of primary and secondary functions. If the set time has not expired, the secondary function is terminated and the primary function is activated, according to step 105 of FIG. 3. In the instance where key 11 is held for a period that exceeds the set period, then the primary function is maintained, according to step 106 of FIG. 3.

In an alternate embodiment, as indicated in FIG. 3, the mobile communication device 1 is provided with a push-over-cellular (PoC) feature 15. This feature is mapped via a software algorithm, resident in memory 4, to the key 11, which in this embodiment operates as the send key of mobile telephone module 8. According to common practice, in the non-calling state, the primary function of the send key is to activate the call log/history feature 16. With the mapping of the PoC feature to key 11, the secondary function becomes the PoC feature 15. In order to avoid the delay, generated by prior art key functioning, the PoC function 15 is activated upon the depression of key 11 and will remain activated, unless key 11 is released prior to the expiration of the set time period, whereupon the call log/history function 16 will be activated.

It should be understood that the above description is only illustrative of the invention. Various alternatives and modifications can be devised by those skilled in the art with out departing from the invention. Accordingly, the present invention is intended to embrace all such alternatives, modifications and variances which fall with the scope of the appended claims.

We claim:

1. An electronic device, adapted to provide at least a primary function and a secondary function, comprising:
a processor for providing computer functions in support of said primary and secondary functions;
a memory for providing a storage resource for said processor in support of said primary and secondary functions;
a key movable in first and second directions for activating the primary and secondary functions;
a sensor for detecting movement of the key in the first and second directions;
a timer for timing the period of time that expires between movement in the first direction and movement in the second direction; and
wherein said processor activates the secondary function in response to movement in the first direction, compares the expired period of time to a predetermined period of time and, if said expired period exceeds said predetermined period, maintains activation of the secondary function or if said expired period is less than said predetermined period, terminates said secondary function and activates said primary function.

2. The electronic device according to claim 1, wherein the first direction of movement is downward and the second movement is upward.

3. The electronic device according to claim 1 wherein said device provides a mobile communication function and said primary function is a call log/history function and said secondary function is a push-over-cellular function.

4. A mobile communication device for providing multiple modes of use, having a control processor adapted to provide at least a primary function and a secondary function, said mobile communication device comprising:
a key movable in first and second directions for activating said primary and secondary functions further comprising:
a sensor for detecting movement of the key in the first and second directions;
a timer for timing the period of time that expires between movement in the first direction and movement in the second direction; and
wherein said processor activates the secondary function in response to movement in the first direction, compares the expired period of time to a predetermined period of time and, if said expired period exceeds said predetermined period, maintains activation of the secondary function or if said expired period is less than said predetermined period, terminates said secondary function and activates said primary function.

5. The mobile communication device according to claim 4, wherein the first direction of movement is downward and the second direction of movement is upward.

6. The mobile communication device according to claim 4 wherein said primary function is a call log/history function and said secondary function is a push-over-cellular function.

7. A method for activating a primary and secondary function of a key in an electronic device having a control processor, said method comprising the steps of:
detecting movement of the key in a first direction;
activating the secondary function in response to the movement of the key in the first direction;
detecting movement of the key in a second direction;
maintaining the activation of the secondary function;
timing the period of time that expires between movement in the first and second directions; and
comparing the expired period of time to a predetermined period of time and, if said expired period is less than said predetermined period, terminating said secondary function and activating said primary function.

8. The method according to claim 11 wherein the first movement is downward and the second movement is upward.

9. The method according to claim 11 wherein said primary function is a call log/history function and said secondary function is a push-over-cellular function.

10. A computer program product for activating a primary and secondary function in an electronic device having a control processor for reading computer readable code, processor operatively associated with an electronic device, said computer program product comprising computer readable code for instructing said processor to cause said electronic device to:
detect movement of a key in a first direction;
activate the secondary function in response to the movement in the first direction;
detect movement of the key in a second direction;
maintain activation of the secondary function;
time the period of time that expires between movement in the first and second directions; and
compare the expired period of time to a predetermined period of time and, if the expired period is less than the predetermined period, terminate said secondary function and activate said primary function.

11. The computer program product according to claim 10 wherein the first movement is downward and the second movement is upward.

12. The a computer program product according to claim 10 wherein said primary function is a call log/history function and said secondary function is a push-over-cellular function.
